(19) United States
(12) Patent Application Publication
(10) Pub. No.: US 2007/0273835 A1
(43) Pub. Date: Nov. 29, 2007

(54) Digital projector with timer

(76) Inventors: Bin Fan, Shanghai (CN); Jianxin Shao, Shanghai (CN)

Correspondence Address: FISH & RICHARDSON PC, P.O. BOX 1022, MINNEAPOLIS, MN, 55440-1022, US

(21) Appl. No.: 11/503,668

(22) Filed: Aug. 14, 2006

(30) Foreign Application Priority Data
May 29, 2006 (CN) 200610083624.X

(51) Int. Cl. G03B 21/00

(52) U.S. Cl. 353/7

(57) ABSTRACT

An apparatus includes a digital projector capable of projecting two-dimensional (2D) and stereoscopic images, and a controller to control the digital projector to project images based on the image signals. The controller controls the digital projector to switch from projecting stereoscopic images to projecting 2D images based upon a timer signal indicating that the digital projector has continuously projected stereoscopic images for a first preset period of time.

### CROSS-REFERENCE TO RELATED APPLICATIONS

This application claims priority to Chinese application serial no. 200610083624.X, filed May 29, 2006, the contents of which are incorporated by reference. This application is related to concurrently filed U.S. patent application Ser. No. ______, titled “Portable Electronic Device Having Built-In Projector” (attorney docket 17707-006001), the contents of which are herein incorporated by reference.

### BACKGROUND OF THE INVENTION

The description relates to digital projectors with timers.

A stereoscopic image can be projected onto a screen by projecting a pair of images intended for the left and right eyes, respectively, on the screen. For example, a digital projector can project on the screen a first image intended for the left eye and having a horizontal polarization, and a second image intended for the right eye and having a vertical polarization. The user can view the stereoscopic image using a pair of eyeglasses in which the left and right eye pieces allow passage of light having horizontal and vertical polarizations, respectively. A stereoscopic video can be projected by projecting a sequence of stereoscopic images.

### SUMMARY

In one aspect, in general, an apparatus includes a digital projector capable of projecting two-dimensional (2D) and stereoscopic images, and a controller to control the digital projector to project images based on the image signals, the controller controlling the digital projector to switch from projecting stereoscopic images to projecting 2D images based upon a timer signal indicating that the digital projector has continuously projected stereoscopic images for a first preset period of time.

Implementations of the apparatus may include one or more of the following features. The controller controls the digital projector to switch back to projecting stereoscopic images based upon the timer signal indicating that the digital projector has projected the 2D images for a second preset period of time. The apparatus includes a hardware or software switch to enable a user to select whether to project 2D images or stereoscopic images. The digital projector includes a light source to generate a light beam, a beam splitter to split the light beam into a first sub-beam and a second sub-beam, a first light modulator to modulate the first sub-beam to generate a first image intended to be viewed by the left eye of a viewer, and a second light modulator to modulate the second sub-beam to generate a second image intended to be viewed by the right eye of the viewer. Each of the first and second light modulators includes a liquid crystal on silicon (LCOS) microdisplay. Each LCOS microdisplay includes an array of dichroic filters, each dichroic filter passing portions of the light beam having wavelengths within a specified range and reflecting portions of the light beam having wavelengths outside of the specified range. The controller controls the digital projector to generate 2D images by sending a common image signal to both the first and second light modulators. The controller receives a pair of images intended for the left and right eyes, respectively, of a user, selects one of the pair of images, and sends the selected image to both the first and second light modulators so that the selected image is projected as a 2D image. The light source includes at least one light emitting device and binary optics elements. The binary optics elements perform at least one of collimating and homogenizing light emitted from the at least one light emitting diode.

In another aspect, in general, an apparatus includes a digital projector capable of projecting two-dimensional (2D) and stereoscopic images, and a controller to control the digital projector to project stereoscopic images and generating a first indicator based upon a timer signal indicating that the digital projector has continuously projected stereoscopic images for a first preset period of time.

Implementations of the apparatus may include one or more of the following features. The indicator includes a beep or a sound alarm. The indicator includes a text or image that is superimposed on the stereoscopic images. The indicator includes a message (a) indicating that the digital projector has continuously projected stereoscopic images for the first preset period of time, or (b) suggesting a viewer to switch to showing 2D images. The controller controls the digital projector to project 2D images and causing a second indicator to be superimposed on the 2D images based upon the timer signal indicating that 2D images have been continuously projected for a second preset period of time.

In another aspect, in general, a video game console includes a digital projector capable of projecting two-dimensional (2D) and stereoscopic images, a storage to store code associated with a video game, a data processor to execute the code and generate stereoscopic image data associated with scenes in the video game, and a graphics controller to control the digital projector to project stereoscopic images based on the stereoscopic image data, the graphics controller controlling the digital projector to switch from projecting stereoscopic images to projecting 2D images based upon a timer signal indicating that the digital projector has continuously projected stereoscopic images for a first preset period of time.

Implementations of the video game console may include one or more of the following features. The controller controls the digital projector to switch back to projecting 3D images based upon the timer signal indicating that the digital projector has projected 2D images for a second preset period of time. The digital projector includes a light source to generate a light beam, a beam splitter to split the light beam into a first sub-beam and a second sub-beam, a first liquid crystal on silicon (LCOS) microdisplay to modulate the first sub-beam to generate a first image intended to be viewed by the left eye of a viewer, and a second LCOS microdisplay to modulate the second sub-beam to generate a second image intended to be viewed by the right eye of the viewer. Each of the first and second LCOS microdisplays includes an array of dichroic filters, each dichroic filter passing portions of the light beam having wavelengths within a specified range and reflecting portions of the light beam having wavelengths outside of the specified range.

In another aspect, in general, a method includes projecting stereoscopic images on a display screen, keeping track of the duration that stereoscopic images have been projected on the display screen, and changing to projecting two-dimensional (2D) images based upon a timer signal indicating that stereoscopic images have been projected on the display screen for a first preset period of time.

Implementations of the method may include one or more of the following features. The method includes switching to projecting stereoscopic images based upon the timer signal indicating that the digital projector has projected 2D images for a second preset period of time. The method includes, at a preset period prior to changing from projecting stereoscopic images to projecting 2D images, showing a countdown indicator on the display screen to indicate how much time is left until actually changing to projecting 2D images. Projecting stereoscopic images includes generating a light beam from a light source, splitting the light beam into a first sub-beam and a second sub-beam, modulating the first sub-beam to generate a first image intended to be viewed by the left eye of a viewer, and modulating the second sub-beam to generate a second image intended to be viewed by the right eye of the viewer. Modulating the first sub-beam includes directing the first sub-beam towards an array of liquid crystal cells and an array of dichroic filters, each dichroic filter passing portions of the first sub-beam having wavelengths within a specified range and reflecting portions of the first sub-beam having wavelengths outside of the specified range. Projecting the 2D images includes modulating the first and second sub-beams based on a common image signal. Projecting the 2D images includes selecting one of the first image and the second image, and modulating both the first and second sub-beams based on the selected image.

Advantages of the apparatus include one or more of the following. The timer reminds a user that the digital projector has continuously projected stereoscopic images for a preset period of time, reducing likelihood of harm caused by viewing stereoscopic images for a prolonged period of time. The apparatus can remind the user using a number of methods, including a reminder message, a beeping sound, or a blinking light.

### DESCRIPTION OF DRAWINGS

FIG. 1A shows a digital camera.

FIG. 1B is a diagram of an arrangement of focusing lens and an image sensor.

FIG. 2 shows a digital projector.

FIG. 3 is a schematic diagram of the digital projector.

FIG. 4A is a schematic diagram of a light source.

FIGS. 4B and 4C are schematic diagrams of binary optics elements.

FIGS. 5 and 6 are schematic diagrams of light sources.

FIG. 7 shows a digital camera.

FIG. 8 is a schematic diagram of a digital projector.

FIG. 9A is a perspective view of a portable computer.

FIG. 9B is a block diagram of a portable computer.

FIG. 10 shows a graphics user interface.

FIG. 11 shows a video game console.

FIG. 12 shows a schematic diagram of a digital camera.

FIG. 13 is a block diagram of an electronic device.

### DESCRIPTION

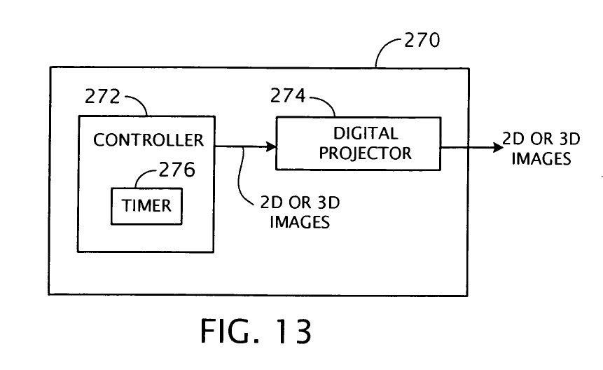

Referring to FIG. 13, an electronic device 270 includes a controller 272 and a digital projector 274 that is capable of projecting either 2D or 3D images. The controller 272 generates 2D or 3D images signals that are sent to the digital projector 274 to project 2D or 3D images, respectively, on an external display screen. A timer 276 keeps track of the duration of time that 3D images have been continuously projected by the digital projector 274. The controller 272 can be configured to generate a reminder to a viewer when 3D images have been shown continuously for a preset period of time. The viewer can be reminded to switch to showing 2D images to reduce stress to the eyes from continuously viewing 3D images. The controller 272 can switch to sending 2D image signals to the digital projector 274 for a second preset period of time, then switch back to sending 3D image signals to the digital projector 274, and so forth.

The electronic device 270 can be any device that uses a display, e.g., a camera, a computer, a video player, or a game player. Having the timer 276 is useful in a portable device having built-in miniature digital projector in which the user may view 3D images for a long period of time.

A portable electronic device having a built-in miniature digital projector can project images that are not limited by the size of the portable electronic device. For example, the miniature digital projector may include a miniature light source that has light emitting diodes (LEDs) for generating light, and binary optics devices for collimating and homogenizing the light to generate a homogeneous light beam. The miniature digital projector includes a miniature image generator that uses liquid crystal on silicon (LCOS) microdisplays to modulate the homogeneous light beam to generate images. The LCOS microdisplays can include an array of micro dichroic filters that each pass light of a certain color and reflect light of other colors.

The miniature image generator may include two LCOS microdisplays that are used to generate two images having different sets of three primary colors. The two images can be combined to generate a projected image having six primary colors. The two LCOS microdisplays can also be used to generate a stereoscopic image by combining two images that are intended to be viewed by the left and right eyes, respectively, of a user.

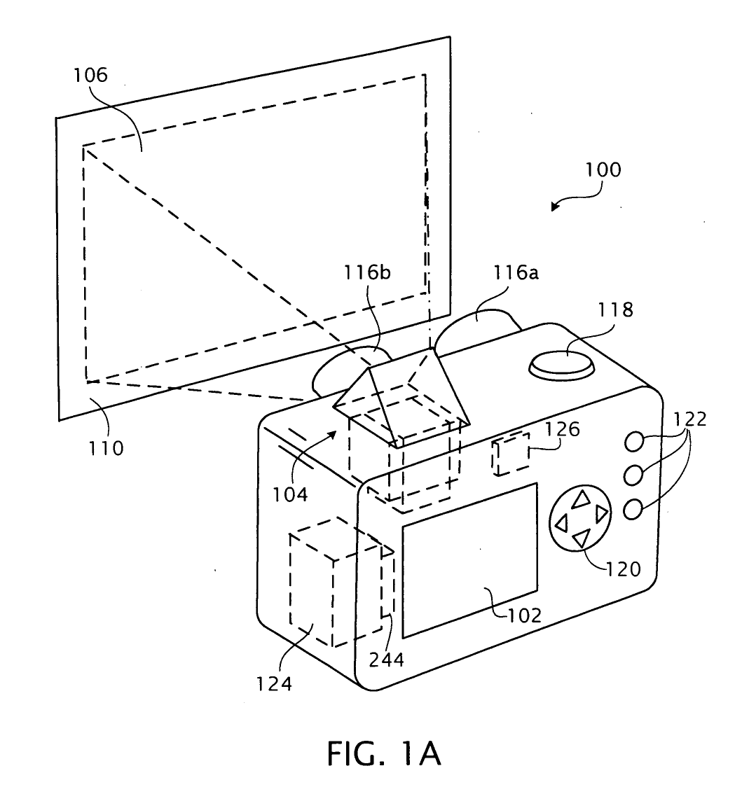

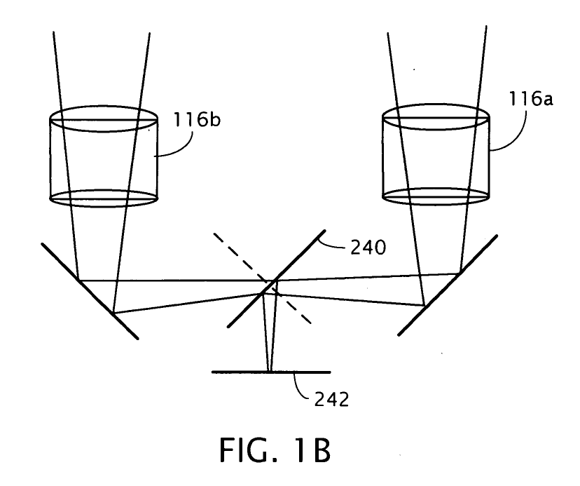

Referring to FIGS. 1A and 1B, an example of a 3D digital camera 100 includes a liquid crystal display (LCD) panel 102 and a built-in digital projector 104. The LCD panel 102 can show a 2D image having a size less than the size of the camera 100, whereas the digital projector 104 can project a 3D image 106 on a screen 110 that can be larger than the size of the camera 100. By having both the LCD panel 102 and the digital projector 104, a user can choose between viewing smaller 2D images directly on the LCD panel 102, larger 3D projected images having higher resolutions, or both.

In some examples, the LCD panel 102 can have a diagonal size of, e.g., 2 inches and a resolution of, e.g., 640×480. The images projected by the digital projector 104 can have a diagonal size of, e.g., 15 inches and a resolution of, e.g., 1280×960.

The digital camera 100 may have a pair of focusing lenses 116a and 116b for focusing a pair of images onto an image sensor 242, e.g., a CMOS or CCD image sensor (FIG. 1B). A swing mirror 240 (FIG. 1B) having adjustable positions can be used to direct light from either the lens 116a or the lens 116b to the image sensor 242. The swing mirror 240 enables the image sensor 242 to capture images focused by the lens 116a and 116b, which correspond to images seen by the right eye and the left eye, respectively, of the user.

A digital signal processor 126 processes the signals from the image sensor 242 to generate image data that can be stored in a storage medium 244, e.g., a flash memory card. The processor 126 controls the display of images by the LCD panel 102 and the projector 104. The camera 100 includes control mechanisms, such as a shutter button 118, menu navigation buttons 120, and operation buttons 122, to control the operation of the camera 100. A battery 124 provides the power for operating the camera 100, including power to the LCD panel 102 and the digital projector 104.

The camera 100 may include a timer (not shown in the figure) to keep track of the duration that 3D images are projected by the digital projector 104. The digital signal processor 126 may generate an indicator to remind the user that 3D images have been projected for a preset period of time and recommend the user to switch to showing 2D images. The indicator can be an audio or visual signal.

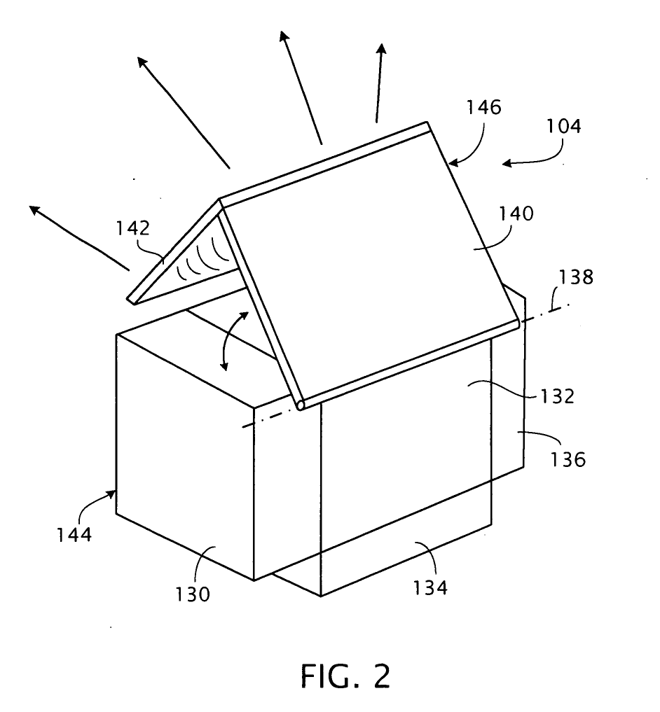

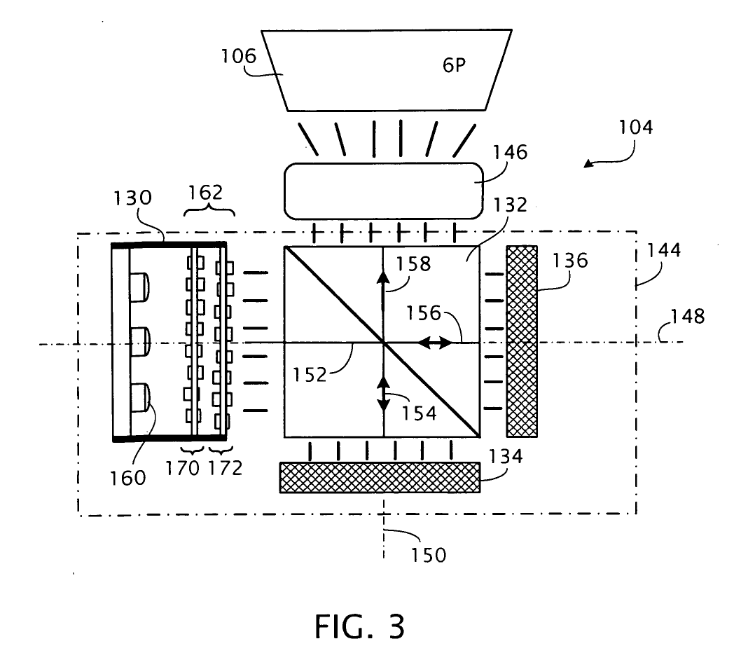

FIG. 2 shows a perspective view of the digital projector 104. FIG. 3 shows a schematic diagram of the digital projector 104. Referring to FIGS. 2 and 3, the digital projector 104 includes an image generator 144 and projection optics 146. The image generator 144 includes a light source 130, a polarizing beam splitter (PBS) 132, a first light modulator 134, and a second light modulator 136. The light source 130, the polarizing beam splitter 132, and the second light modulator 136 are aligned along a first optical axis 148. The first light modulator 150 and the polarizing beam splitter 132 are aligned along a second optical axis 150.

The light source 130 generates a homogeneous light beam 152 having a uniform brightness. The polarizing beam splitter 132 splits the light beam 152 into two beams 154 and 156 having different polarizations. When projecting a 3D image composed of a pair of 2D images captured through the focusing lens 116a and 116b, the first and second light modulators 134 and 136 modulate the light beams 154 and 156 to reproduce the images that are captured through the focusing lenses 116a and 116b, respectively. The images generated by the light modulators 134 and 136 are combined by the PBS 132 into a stereoscopic (3D) image. The stereoscopic image is projected upwards and redirected by the projection optics 146 towards the screen 110.

The stereoscopic image includes two images projected by light having different polarizations. For example, one image intended for the left eye may have a horizontal polarization, and the other image intended for the right eye may have a vertical polarization. The user can view the stereoscopic image using a pair of eyeglasses in which the left and right eye pieces allow passage of light having horizontal and vertical polarizations, respectively.

The projection optics 146 can include, e.g., a mirror 140 and a lens module 142. The mirror 140 reflects light from the image generator 144 so that the upward projected image is redirected in a forward direction towards the screen 110. The projection optics 146 is coupled to the camera body through hinges such that the projection optics 146 are rotatable about an axis 138 (FIG. 2). The projection direction of the image 110 can be adjusted by rotating the projection optics 146 relative to the axis 138. The lens module 142 focuses the projected image 106 on the screen 110. The projection optics 146 can be folded into the camera body when not in use.

The light source 130 can include, for example, light emitting diodes (LEDs) 160 for generating light. The LEDs 160 can be one or more white LEDs, or a combination of red, green, and blue LEDs. Light emitted from the LEDs 160 can be collimated and homogenized using, for example, a combination 162 of a collimating lens 170 and a fly's eye integrator 172. The collimating lens 170 and/or the fly's eye integrator 172 can be made of, e.g., multi-step binary optics devices that are fabricated on one or more substrates using photolithography methods.

The light modulators 134 and 136 can be, for example, liquid crystal on silicon (LCOS) microdisplays each having a resolution of, e.g., 1280×960. Depending on the resolution and the size of each pixel cell, the LCOS microdisplays can have a diagonal size of, e.g., 0.3 to 1.8 inches. The light source 130 and the PBS 132 have dimensions that match the dimensions of the LCOS microdisplays 134 and 136, so the overall size of the digital projector 104 can be made small. The LCOS microdisplays can use an array of dichroic color filters to generate color images.

Each of the LCOS microdisplays 134 and 136 includes a silicon substrate having pixel circuits disposed thereon, an array of metal reflectors, a liquid crystal layer, a layer of transparent electrode, an array of micro dichroic filters, and a cover substrate. Each dichroic filter allows light of a certain color (i.e., light within a certain range of wavelengths) to pass, and reflects light of other colors. In some examples, each pixel of the microdisplay includes three sub-pixels, each sub-pixel corresponding to one of three dichroic filters that allow red, green, and blue colors to pass, respectively. Such pixels can exhibit colors composed of red, green, and blue colors. In some examples, each pixel includes three sub-pixels, each sub-pixel corresponding to one of three dichroic filters that allow cyan, magenta, and yellow colors to pass, respectively. Such pixels can exhibit colors composed of cyan, magenta, and yellow colors.

When a white light beam from the light source 130 irradiates a sub-pixel of the LCOS microdisplay, a portion of the light beam not within the pass band of the dichroic filter is reflected without changing its polarization. The portion of the light beam that passes the dichroic filter passes the liquid crystal layer, is reflected by the metal reflector, then passes the liquid crystal layer and the dichroic filter a second time. As light passes the liquid crystal layer, the polarization of the light may change, depending on the orientation of the liquid crystal molecules in the liquid crystal layer, which in turn is controlled by the voltage applied across the liquid crystal layer.

The light that passes the dichroic filters are modulated by the liquid crystal layer to form an image that is projected on the screen 110 through the projection optics 146. The light that is reflected from the dichroic filters can be recycled to increase optical efficiency.

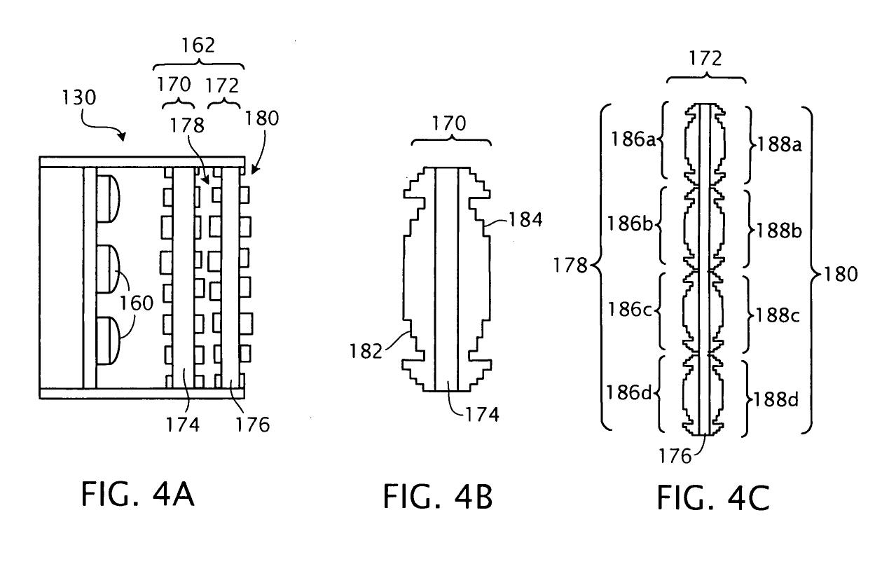

Referring to FIG. 4A, in some examples, the collimating lens 170 is fabricated on a first glass substrate 174, and the fly's eye integrator 172 is fabricated on a second glass substrate 176. The fly's eye integrator 172 includes a first fly's eye lens array 178 fabricated on a first side of the glass substrate 176, and a second fly's eye lens array 180 fabricated on a second side of the glass substrate 176.

Referring to FIG. 4B, the collimating lens 170 is a binary optics element that has multiple levels. The collimating lens 170 includes a multilevel surface profile 182 on one side of the substrate 174 and a multilevel surface profile 184 on another side of the substrate 174. The multilevel surface profile 182 performs a function equivalent to a first convex surface of a discrete convex lens, and the multilevel surface profile 184 performs a function equivalent to a second convex surface of the discrete convex lens. The collimating lens 172 can perform a function equivalent to a spherical lens or a non-spherical lens.

Referring to FIG. 4C (which is not to scale), the first fly's eye lens array 178 includes an array of lenses, such as 186a to 186d. The second fly's eye lens array 180 includes an array of lenses, such as 188a to 188d. Each lens 186a-186d and 188a-188d is a binary optics element that has multiple levels. The lenses are fabricated using photolithography techniques. Each of the lens in the arrays 178 and 180 can perform a function equivalent to a spherical lens or a non-spherical lens.

Advantages of using multi-step binary optics devices is that the collimating lens 170 and/or the fly's eye integrator 172 can be made thin, so that the overall size of the light source 130 can be made small. The collimating lens 170 and the fly's eye integrator 172 can be built into the front cover of the light source 130. The binary optics elements can have arbitrary profiles, so it is easier to fabricate binary optics elements that perform the functions of non-spherical discrete optical elements, reducing or preventing aberrations.

Using photolithography methods to fabricate the binary optics devices enables each lens in the array of lenses to be made small, e.g., having 100 μm in diameter. Light emitted from each LED passes through several small lenses, in which light passing different lens overlap one another to produce homogeneous light. Mass-producing the binary optics devices using photolithography techniques also reduces the cost of the collimating lens 170 and the fly's eye integrator 172.

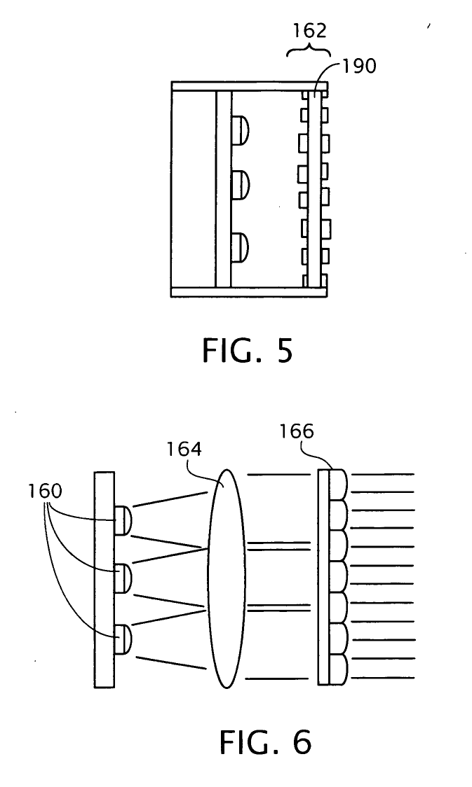

Referring to FIG. 5, the combination 162 of the collimating lens and the fly's eye integrator can be fabricated on a single substrate 190.

For a slightly larger camera, the light source 130 can use conventional lens, as shown in FIG. 6. A collimating lens 164 collimates light emitted from the LEDs 160. A fly's eye array 166 homogenizes the collimated light to generate a homogeneous light beam having a uniform brightness.

Examples of LCOS microdisplays are described in International Application No. PCT/CN03/00348, filed on May 14, 2003, and corresponding U.S. patent application Ser. No. 10/506,264, titled “A SILICON-BASED COLOR LIQUID CRYSTAL DISPLAY MICRODEVICE,” filed on Oct. 8, 2004, the contents of which are incorporated by reference.

Examples of microdisplays that use interference filter arrays are described in U.S. patent application Ser. No. 11/141,737, filed Jun. 1, 2005, titled “FILTER ARRAYS FOR LIQUID CRYSTAL DISPLAYS AND METHODS OF MAKING THE SAME,” the contents of which are incorporated by reference.

Examples of projection display systems that utilize LCOS microdisplays are described in International Application No. PCT/CN2004/000110 filed on Feb. 10, 2004, and corresponding U.S. patent application Ser. No. 10/506,304, titled “A COLOR PROJECTION DISPLAY SYSTEM,” filed on Sep. 1, 2004, the contents of which are incorporated by reference. The projection display system described in U.S. patent application Ser. No. 10/506,304, titled “A COLOR PROJECTION DISPLAY SYSTEM” uses a light source having discrete optical components.

The camera 100 can be operated to capture 2D images through one focusing lens 116a. The digital projector 104 can project 2D images by sending the same image signal to the first and second light modulators 134 and 136.

Advantages of the camera 100 include the following. The size of the images being projected is not limited by the size of the camera 100, so even a compact camera can project a large image. The projected image 106 can have a larger size and a higher resolution (than images shown on the LCD panel 102), so the user can more easily view details of the images captured by the camera 100. It is also easier to share the large projected images with multiple people. Stereoscopic images can be projected on an external display screen 110.

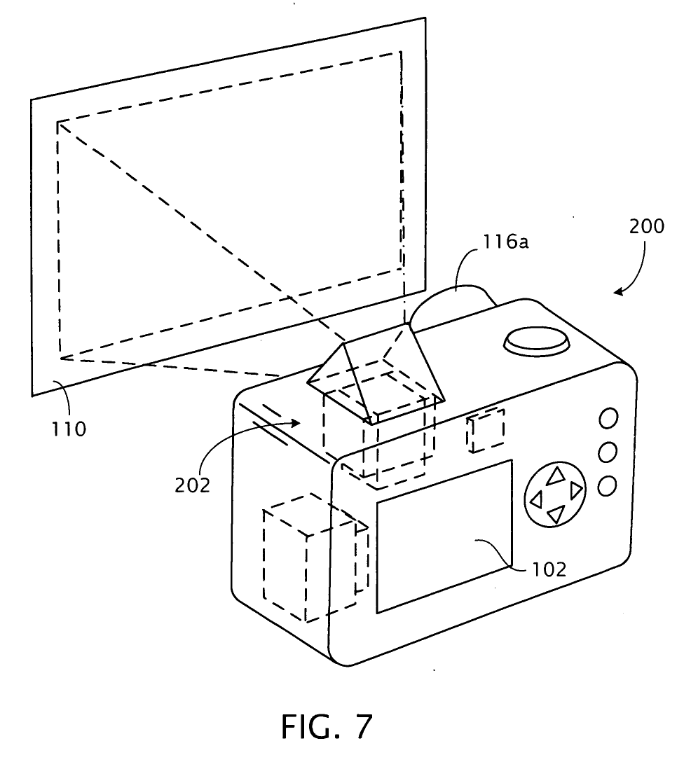

FIG. 7 shows an example of a digital camera 200 that is similar to the digital camera 100 except that the camera 200 has one focusing lens 116a for focusing light onto one image sensor. The digital camera 200 captures 2D images and projects 2D images using a digital projector 202.

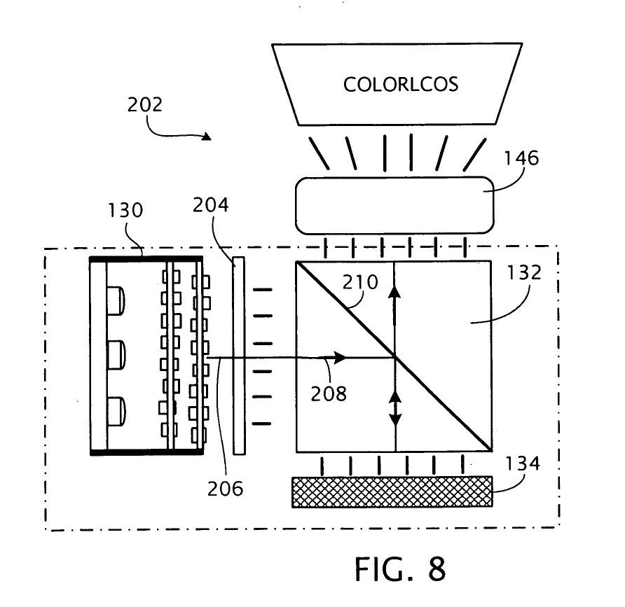

FIG. 8 shows a schematic diagram of the digital projector 202, which is similar to the digital projector 104 except that the projector 202 has only one light modulator 134 and has an additional polarizer 204. A light source 130 generates a homogeneous light beam 206 that passes the polarizer 204, generating a polarized light beam 208. A polarizing beam splitting surface 210 directs the polarized light beam 208 towards the light modulator 134, which modulates the light beam 208 to generate an image. The modulated light is projected upwards and redirected by the projection optics 146 towards a display screen 110.

The digital camera 200 can also use the digital projector 104. In this case, the light modulators 134 and 136 receive the same image signal so that the projected images are 2D images.

Because of their small sizes, the digital projectors 104 and 202 can be used in many portable electronic devices.

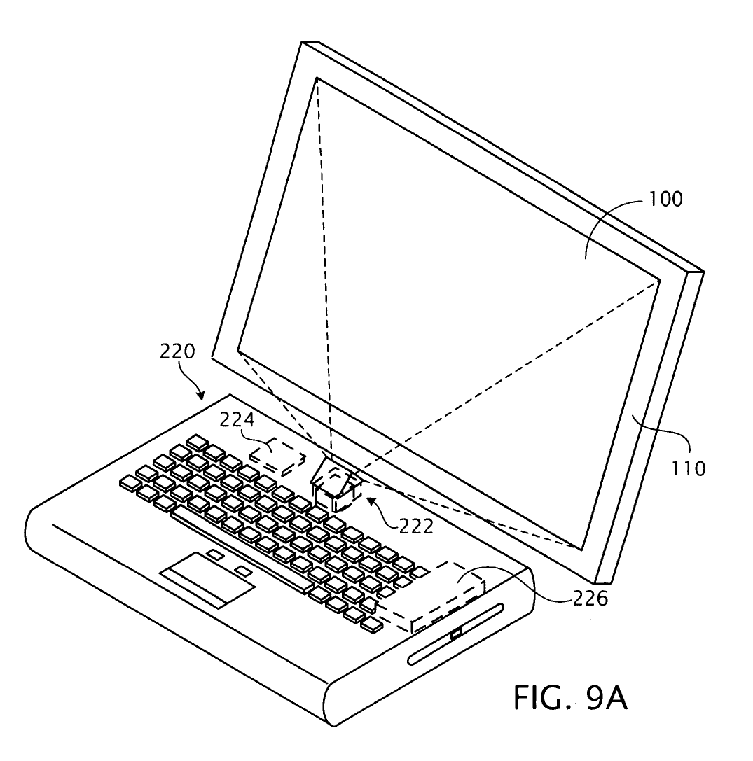

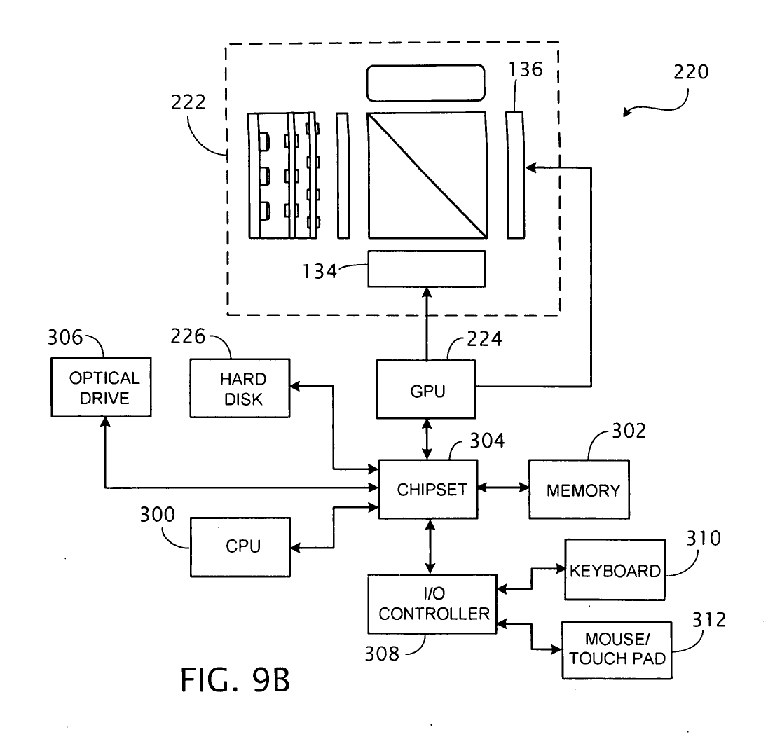

FIG. 9A is a perspective view of an example of a portable computer 220 that includes a built-in digital projector 222 that can project images 106 having sizes larger than the portable computer 220 (the drawing is not to scale). The digital projector 222 is similar to the digital projector 104, and has a first light modulator 134 and a second light modulator 136 (see FIG. 3). FIG. 9B is a block diagram of the portable computer 220.

The portable computer 220 includes a graphics processing unit (GPU) 224 for controlling the digital projector 222. The GPU 224 can control the digital projector 222 to project 3D images by sending pairs of images to the light modulators 134 and 136, in which each pair of images correspond to images intended to be seen by the left and right eyes, respectively, of the user. The GPU 224 can also control the digital projector 222 to project 2D images by sending the same image signal to the light modulators 134 and 136.

In some examples, the first light modulator 134 is configured to modulate a first polarized beam 154 such that the first modulated beam has a first set of three primary colors—red, green, and blue. The second light modulator 136 is configured to modulate a second polarized beam 156 such that the second modulated beam has a second set of three primary colors—cyan, magenta, and yellow.

The GPU 224 can control the digital projector 222 to project 2D images having six primary colors, referred to as 6P images. For example, a 6P image can have red, green, blue, cyan, magenta, and yellow colors. The GPU 224 can send an image signal representing the red, green, and blue color components of the 6P image to the first light modulator 134, and send an image signal representing the cyan, magenta, and yellow color components of the 6P image to the second light modulator 136. The projected image 106 includes modulated light from the first and second light modulators 134 and 136, and thus has six primary colors, resulting in an image having richer colors than if the image were composed of only three primary colors. Showing images using six primary colors can be useful in displaying photographs with accurate colors.

The portable computer 220 includes a central processing unit (CPU) 300 for executing code, such as code for an operating system and application programs. The code is stored in a hard disk drive 226 and loaded into a memory 302 during execution by the CPU 300. An optical disc drive 306 allows reading data from and writing data to optical discs. The optical disc drive 306 can be used to view videos, such as movies, and play video games stored on optical discs. A chipset controller 304 (or a number of chipset controllers) communicates with the CPU 300 and controls access to the hard disk drive 226, the optical disc drive 306, the GPU 224, and the memory 302. The chipset controller 304 is connected to an input/output controller 308 that connects to a keyboard 310 and a mouse or touch pad 312. The keyboard 310 allows a user to enter data for use by the operating system and application programs or to control execution of the operating system and the application programs. The operating system provides a graphical user interface (GUI) that includes windows for displaying the outputs of application programs.

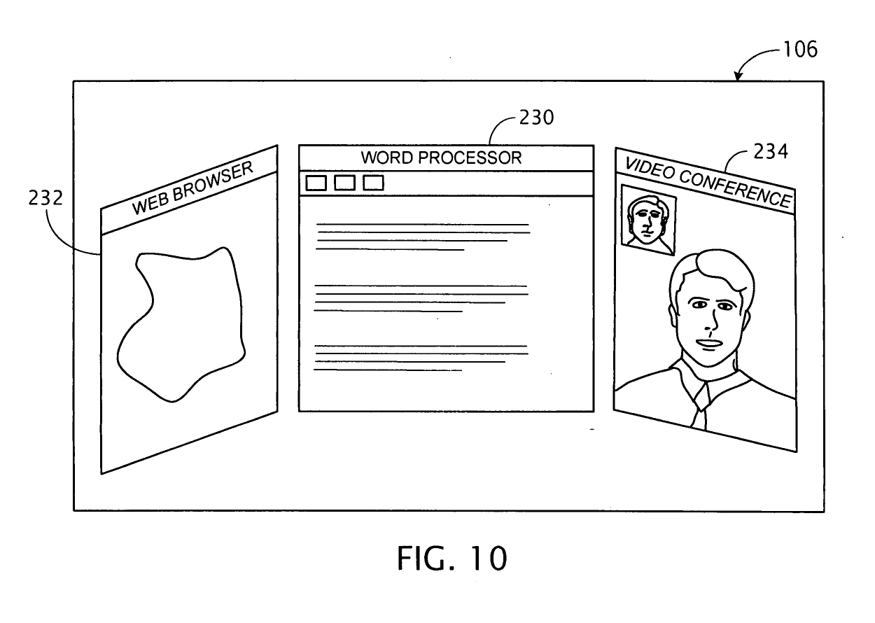

Referring to FIG. 10, for example, a first window 230 may display the output of a word processing program, a second window 232 may display the output of a web browser, and a third window 234 may display the output of a video conferencing program.

The operating system may generate image signals to enable the windows 230, 232, and 234 to be shown in three dimension. The operating system generates a first image signal representing a first image of the windows 230, 232, and 234 as seen by the left eye of the user, and a second image signal representing a second image of the windows 230, 232, and 234 as seen by the right eye of the user. The GPU controls the first and second light modulators 134 and 136 using the first and second image signals, respectively, so that the digital projector 222 projects a stereoscopic image 106 on the screen 110, showing the windows 230, 232, and 234 in three dimension.

The hard disk drive 226 may store code of a video game program that generates 3D images in a video game. For each scene in the video game, the video game program generates a first image signal representing a first view of the scene as seen by the left eye of the user, and a second image signal representing a second view of the scene as seen by the right eye of the user. The GPU 224 controls the first and second light modulators 134 and 136 using the first and second image signals, respectively, so that the digital projector 222 projects a 3D image 106 on the screen 110, showing the scene in three dimension.

The operating system may include a timer application that keeps track of the duration that 3D images are projected by the digital projector 222. Viewing 3D images may cause more stress to the eyes, as compared to viewing 2D images. The operating system can be configured to show 3D images continuously for a first preset period of time, then switch to showing 2D images for a second preset period of time to allow the eyes to rest, then switch back to showing 3D images for the first preset period of time, and so forth. For example, the first preset period of time can be 10 minutes, and the second preset period of time can be 1 minute.

The timer is useful when playing video games, in which the user often concentrates on the game and does not keep track of time. Without the timer, the user may view 3D images for a prolonged period of time, causing harm to the eyes.

The operating system may cause a reminder message (e.g., “You have been viewing 3D images for over n minutes” or “Please take a rest or switch to 2D images”) to be shown as part of the projected image 106 when 3D images have been continuously projected by the digital projector 222 for a preset amount of time. For example, the operating system can also cause the portable computer to output a beeping sound, output a blinking icon on the screen, cause an LED to blink, or show a countdown of a timer to remind the user that 3D images have been shown for a long period of time. The operating system lets the user decide whether to continue to view 3D images or switch to viewing 2D images.

Because a built-in digital projector can have small sizes, a portable computer can have more than one built-in digital projector for some special applications.

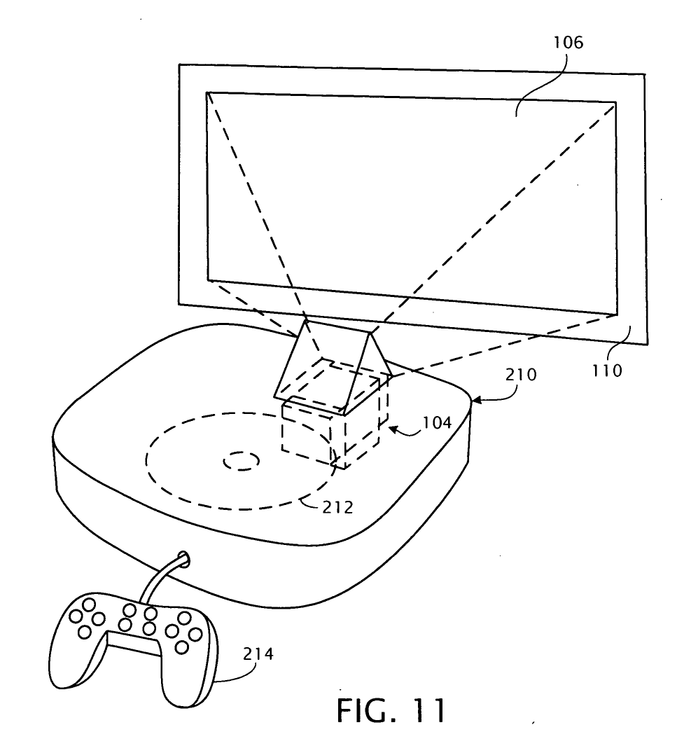

FIG. 11 shows an example of a portable video game console 210 that can be used to play games stored on a storage medium 212, such as an optical disc. The user controls movements of characters in the game using a joystick, steering wheel, or game pad 214. The storage medium 212 can comply with, e.g., Digital Video Disc (DVD), High Definition DVD (HD-DVD), or Blu-ray Disc standard. The storage medium can be read-only, write-once, or rewritable.

The game console 210 includes a built-in digital projector 104 that can project images 106 onto an external display screen 110. The digital projector 104 can be configured to project 2D or 3D images. The digital projector 104 can include light modulators 134 and 136 that are configured such that the projected images are compatible with, e.g., VGA standard (640×480 pixels), XGA standard (1024×768 pixels), SXGA standard (1280×1024 pixels), UXGA standard (1600×1200 pixels), WXGA standard (1366×768 pixels), or HDTV standard (1280×720 or 1920×1080 pixels). Using the digital projector 104, the portable video game console 210 can project images or videos having a higher resolution than if a conventional small size flat panel display were used. The digital projector 104 can project stereoscopic images or images having two sets of primary colors (e.g., red, green, blue, cyan, magenta, and yellow).

The video game console 210 can also be used to show movies stored on the storage medium 212.

### ALTERNATIVE EXAMPLES

Although some examples have been discussed above, other implementations and applications are also within the scope of the following claims. For example, the digital cameras 100 and 200 can be configured to include only the digital projector 104 and 202, respectively, without including the LCD panel 102. The fly's eye integrator 172 in FIG. 3 can be replaced by a rod integrator. In the digital projectors 104 (FIG. 2) and 202 (FIG. 8), the LEDs 160 can be replaced by other light generators, such as a light pipe. The digital projector 104 and 202 can be used in devices other than those described above, such as a digital camcorder, portable phone, a land line telephone, a personal digital assistant, a portable music player, a portable radio, a portable video player, or a digital photo frame. The digital projectors 104 and 202 can be used to replace flat panel displays of personal computers.

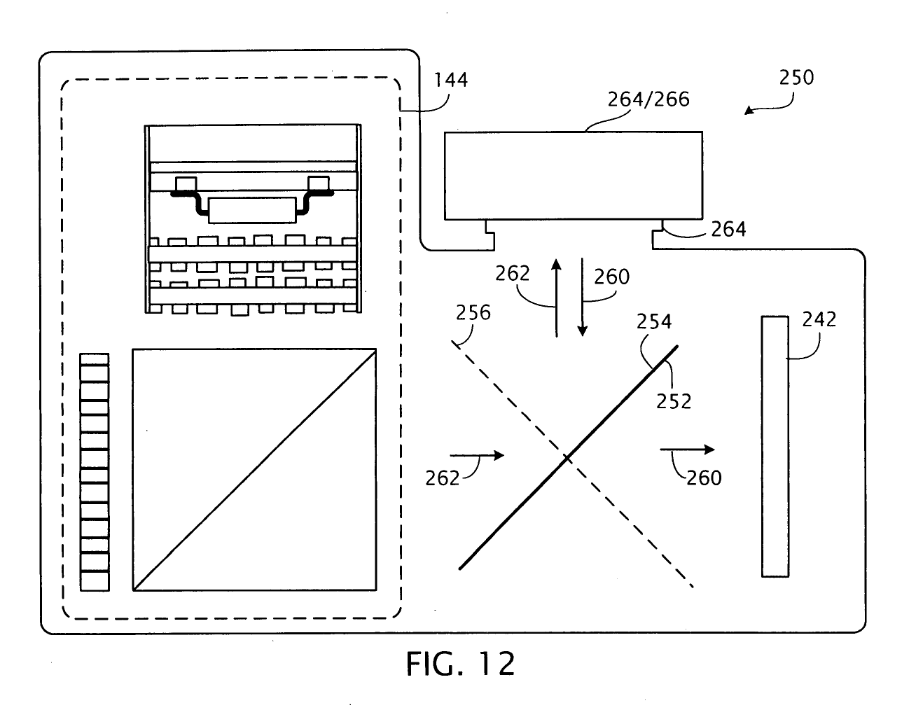

The camera 100 of FIG. 1A uses focusing lens 116a and 116b for focusing the images to be captured by the image sensor 242, and projection optics 146 for focusing images to be projected on the external display screen. In some examples, the projection optics and one of the focusing lens 116a or 116b can share a common lens mount. Referring to FIG. 12, a digital camera 250 includes a image sensor 242, an image generator 144, a swing mirror 252, and a lens mount 264. When the user intends to take a picture, a focusing lens 264 is attached to the lens mount 264, and the swing mirror 252 is adjusted to a position 256. Incoming light 260 that passes the focusing lens 264 is directed towards the image sensor 242. When the user intends to view a projected image, a projection lens 266 is attached to the lens mount 264, and the swing mirror 252 is adjusted to a position 254. Light 262 from the image generator 144 is directed towards the projection lens 266 and projected onto an external display screen. The camera 200 of FIG. 7 can also be modified such that the focusing lens and the projection lens share a common lens mount.

The portable computer of FIG. 9A may include a hardware or software switch to enable a user to select whether to project 2D images or stereoscopic images. The controller 272 and the digital projector 274 of FIG. 13 does not have to be an integrated device and can be separate units.

What is claimed is:

1. An apparatus comprising:
a digital projector capable of projecting two-dimensional (2D) and stereoscopic images; and
a controller to control the digital projector to project images based on the image signals, the controller controlling the digital projector to switch from projecting stereoscopic images to projecting 2D images based upon a timer signal indicating that the digital projector has continuously projected stereoscopic images for a first preset period of time.

2. The apparatus of claim 1 wherein the controller controls the digital projector to switch back to projecting stereoscopic images based upon the timer signal indicating that the digital projector has projected the 2D images for a second preset period of time.

3. The apparatus of claim 1, further comprising a hardware or software switch to enable a user to select whether to project 2D images or stereoscopic images

4. The apparatus of claim 1 wherein the digital projector comprises
a light source to generate a light beam,
a beam splitter to split the light beam into a first sub-beam and a second sub-beam,
a first light modulator to modulate the first sub-beam to generate a first image intended to be viewed by the left eye of a viewer, and
a second light modulator to modulate the second sub-beam to generate a second image intended to be viewed by the right eye of the viewer.

5. The apparatus of claim 4 wherein each of the first and second light modulators comprises a liquid crystal on silicon (LCOS) microdisplay.

6. The apparatus of claim 5 wherein each LCOS microdisplay comprises an array of dichroic filters, each dichroic filter passing portions of the light beam having wavelengths within a specified range and reflecting portions of the light beam having wavelengths outside of the specified range.

7. The apparatus of claim 4 wherein the controller controls the digital projector to generate 2D images by sending a common image signal to both the first and second light modulators.

8. The apparatus of claim 7 wherein the controller receives a pair of images intended for the left and right eyes, respectively, of a user, selects one of the pair of images, and sends the selected image to both the first and second light modulators so that the selected image is projected as a 2D image.

9. The apparatus of claim 4 wherein the light source comprises at least one light emitting device and binary optics elements.

10. The apparatus of claim 9 wherein the binary optics elements perform at least one of collimating and homogenizing light emitted from the at least one light emitting diode.

11. The apparatus of claim 1 wherein the controller comprises a data processor executing code for generating image signals.

12. An apparatus comprising:
a digital projector capable of projecting two-dimensional (2D) and stereoscopic images; and
a controller to control the digital projector to project stereoscopic images and generating a first indicator based upon a timer signal indicating that the digital projector has continuously projected stereoscopic images for a first preset period of time.

13. The apparatus of claim 12 wherein the indicator comprises a beep or a sound alarm.

14. The apparatus of claim 12 wherein the indicator comprises a text or image that is superimposed on the stereoscopic images.

15. The apparatus of claim 14 wherein the indicator comprises a message (a) indicating that the digital projector has continuously projected stereoscopic images for the first preset period of time, or (b) suggesting a viewer to switch to showing 2D images.

16. The apparatus of claim 12 wherein the controller controls the digital projector to project 2D images and causing a second indicator to be superimposed on the 2D images based upon the timer signal indicating that 2D images have been continuously projected for a second preset period of time.

17. A video game console comprising:
a digital projector capable of projecting two-dimensional (2D) and stereoscopic images;
a storage to store code associated with a video game;
a data processor to execute the code and generate stereoscopic image data associated with scenes in the video game; and
a graphics controller to control the digital projector to project stereoscopic images based on the stereoscopic image data, the graphics controller controlling the digital projector to switch from projecting stereoscopic images to projecting 2D images based upon a timer signal indicating that the digital projector has continuously projected stereoscopic images for a first preset period of time.

18. The video game console of claim 17 wherein the controller controls the digital projector to switch back to projecting 3D images based upon the timer signal indicating that the digital projector has projected 2D images for a second preset period of time.

19. The video game console of claim 17 wherein the digital projector comprises
a light source to generate a light beam,
a beam splitter to split the light beam into a first sub-beam and a second sub-beam,
a first liquid crystal on silicon (LCOS) microdisplay to modulate the first sub-beam to generate a first image intended to be viewed by the left eye of a viewer, and
a second LCOS microdisplay to modulate the second sub-beam to generate a second image intended to be viewed by the right eye of the viewer.

20. The video game console of claim 19 wherein each of the first and second LCOS microdisplays comprises an array of dichroic filters, each dichroic filter passing portions of the light beam having wavelengths within a specified range and reflecting portions of the light beam having wavelengths outside of the specified range.

21. A method comprising:
projecting stereoscopic images on a display screen;
keeping track of the duration that stereoscopic images have been projected on the display screen; and
changing to projecting two-dimensional (2D) images based upon a timer signal indicating that stereoscopic images have been projected on the display screen for a first preset period of time.

22. The method of claim 21, further comprising switching to projecting stereoscopic images based upon the timer signal indicating that the digital projector has projected 2D images for a second preset period of time.

23. The method of claim 21, further comprising, at a preset period prior to changing from projecting stereoscopic images to projecting 2D images, showing a countdown indicator on the display screen to indicate how much time is left until actually changing to projecting 2D images.

24. The method of claim 21 wherein projecting stereoscopic images comprises
generating a light beam from a light source,
splitting the light beam into a first sub-beam and a second sub-beam,
modulating the first sub-beam to generate a first image intended to be viewed by the left eye of a viewer, and
modulating the second sub-beam to generate a second image intended to be viewed by the right eye of the viewer.

25. The method of claim 24 wherein modulating the first sub-beam comprises directing the first sub-beam towards an array of liquid crystal cells and an array of dichroic filters, each dichroic filter passing portions of the first sub-beam having wavelengths within a specified range and reflecting portions of the first sub-beam having wavelengths outside of the specified range.

26. The method of claim 24 wherein projecting the 2D images comprises modulating the first and second sub-beams based on a common image signal.

27. The method of claim 26 wherein projecting the 2D images comprises selecting one of the first image and the second image, and modulating both the first and second sub-beams based on the selected image.
